(19) United States
(12) Patent Application Publication
(10) Pub. No.: US 2015/0348114 A1
(43) Pub. Date: Dec. 3, 2015

(54) INFORMATION PROVIDING APPARATUS

(71) Applicant: TOSHIBA TEC KABUSHIKI KAISHA, Tokyo (JP)

(72) Inventors: Hiroyo Tanaka, Tokyo (JP); Akihiko Fujiwara, Kawasaki (JP); Mika Hirama, Tokyo (JP); Shigeo Uchida, Mishima (JP)

(21) Appl. No.: 14/694,058

(22) Filed: Apr. 23, 2015

(30) Foreign Application Priority Data
May 30, 2014 (JP) 2014-113045

(51) Int. Cl. G06Q 30/02; G09F 3/20

(52) U.S. Cl. CPC G06Q 30/0267; G09F 3/208; G06Q 30/0261

(57) ABSTRACT

An information providing apparatus is a device which displays information on a signage device and controls the signage device, and includes an interface and a control unit. The interface transmits data of a management screen for updating one or a plurality of contents displayed on the signage device, to a first terminal device. Further, the interface receives update data of content which is input by using the management screen and data about an update timing from the first terminal device. The control unit updates existing data displayed on the signage device to update data, according to the data about the update timing.

### CROSS-REFERENCE TO RELATED APPLICATION

This application is based upon and claims the benefit of priority from Japanese Patent Application No. 2014-113045, filed May 30, 2014, the entire contents of which are incorporated herein by reference.

### FIELD

Embodiments described herein relate generally to a technology that provides information by using a signage device.

### BACKGROUND

In shops or event venues, typical images for goods and held events are exhibited using signage devices (electronic bulletin boards). Such signage devices display images under the control of computers.

### DESCRIPTION OF THE DRAWINGS

FIG. 1 illustrates a diagram of a configuration example of a system.

FIG. 2 is a block diagram of the system, and illustrates an internal configuration of a server.

FIG. 3 illustrates a display example of a signage device.

FIGS. 4A and 4B illustrate a display example in a portable terminal, and illustrate an operation screen example for maintenance.

FIG. 5 is a flowchart illustrating an operation example of an update process.

FIG. 6 is a flowchart illustrating an operation example when an updating timing of the server is controlled.

FIG. 7 is a flowchart illustrating an operation example when the updating timing of the server is controlled.

FIG. 8 is a diagram illustrating an example of management information of a user.

FIG. 9 is a diagram illustrating a display example of statistical information.

### DETAILED DESCRIPTION

A maintenance person updates display content data of a signage device as necessary.

An object of an embodiment is to provide a technology for controlling an update process of content data displayed on the signage device.

An information providing apparatus of the embodiment is a device which displays information on a signage device and controls the signage device, and includes an interface and a control unit. The interface transmits data of a management screen for updating one or a plurality of contents displayed on the signage device, to a first terminal device. Further, the interface receives update data of content which is input by using the management screen and data about an update timing from the first terminal device. The control unit updates existing data displayed on the signage device to the update data, according to the data about the update timing.

Hereinafter, management, control, and data updating of an information providing apparatus (server) that provides information using a signage device will be described.

The information providing apparatus of the embodiment has a Web server function, and provides an update page depending on the type of device that is connected to an update Web page. Further, the information providing apparatus manages a user in association with an update device, and sets a change range for each user.

The information providing apparatus of the embodiment stores use history and update history as a log, and generates and outputs a report. The type of the report to be generated and the log is set for each user.

In the embodiment, an update time of content displayed on the signage device can be designated. The update timing may be set as “updating at a timing when the portable terminal of a visitor is not connected to the information providing apparatus” in addition to the settings of “immediate” and “designated time”. Another setting is possible in such a manner that a sensor provided in the signage device detects the presence or absence of a person and updating is performed when there is not a person.

The information providing system of the embodiment has a function of delivering the detailed information of the content displayed on the signage device, to the visitor's own portable terminal. In a case of such a signage system, at the timing when the maintenance person is updating the display content of the signage device and the detailed information for delivery, if the detailed information is downloaded, the content displayed on the signage device and the delivered detailed information may be different in some cases. For example, if a delivery process is performed at a timing when only delivery information is updated, the detailed information different from the content that the visitor views on the signage device is delivered. Accordingly, in the present embodiment, as described above, a timing when the visitor does not use the signage device is detected, and the display content is updated at the timing.

Further, a description will be made regarding updating the content by using the content and the attached image of the received e-mail.

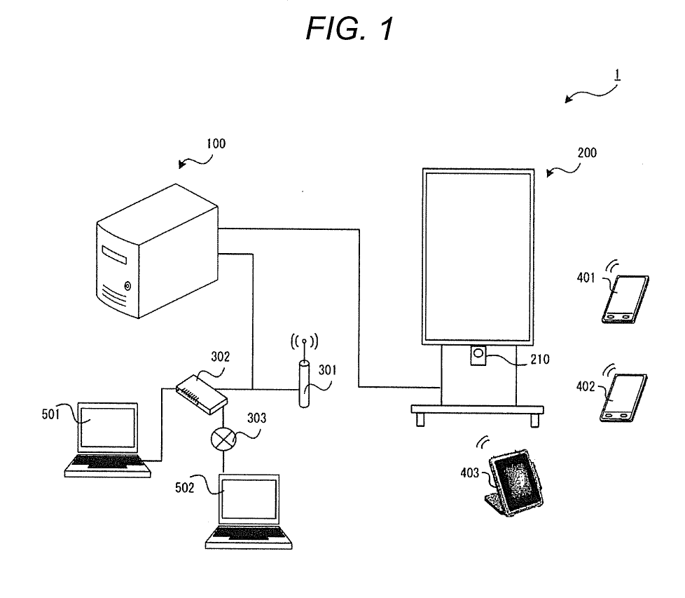

FIG. 1 illustrates a configuration example of a system of an embodiment. An information providing system 1 includes a server 100 (information providing apparatus), a signage device 200, an access point 301, and a router 302. The server 100 and the signage device 200 are connected through, for example, a video input and output cable such as a high definition multimedia interface (HDMI) cable and a digital visual interface (DVI) cable. Further, the server 100, the access point 301, and the router 302 are connected through for example, a local area network (LAN) cable. Further, the server 100 and the signage device 200 may be configured to be connected by using the LAN cable.

The server 100 performs display control of the signage device 200. The server 100 is a computer that transmits and receives information with portable terminals 401 to 403 that a signage administrator and a tenant person (hereinafter, referred to as a maintenance person) own, through the access point 301. Further, the server 100 transmits and receives information with PCs 501 and 502 (personal computer: PC) that the maintenance people use, through the router 302. Further, a wide area network may be used for the communication between the server 100 and the portable terminals 401 to 403, while the access point 301 is not used. In the present embodiment, a Web server and a Web browser are introduced in advance to the server 100.

The signage device 200 is, for example, an electronic bulletin board which is provided in commercial facilities and is installed at a position where visitors and event participants (hereinafter, referred to as users) are capable of viewing the electronic bulletin board. The signage device 200 displays an image in response to an image signal that is output from the server 100. The signage device 200 may emit a sound according to an audio signal that is output from the server 100.

The signage device 200 includes one or a plurality of human sensors 210. The human sensor 210 is a sensor that senses whether a person is present in the vicinity of the signage device 200. The server 100 is connected to the human sensor 210 through a cable, and receives a detection signal about the presence or absence of a person. In addition, a camera is provided, and there may be a method for detecting the presence or absence of a person, based on the information captured by the camera.

The access point 301 is a communication infrastructure device by which the server 100 and the portable terminals 401 to 403 perform wireless communication, and in the present embodiment, encrypted communication that is communication based on the standard of IEEE802.11. The router 302 is a device relaying communication between the external device of the information providing system 1 and the PCs 501 and 502.

The portable terminals 401 to 403 are smartphones and tablets that the maintenance people own, and may be notebook computers. The portable terminals 401 to 403 can perform at least wireless communication, and it is assumed that the Web browser is introduced. The portable terminals 401 to 403 access the Web server of the server 100, by using the Web browser, and acquire a management screen for updating the content displayed on the signage device 200. Further, the portable terminals 401 to 403 display the management screen on touch panel displays, acquire input information and an image from the user through the touch panel displays, and transmit the received input information and image to the server 100. The same operation may also be performed in the PCs 501 and 502.

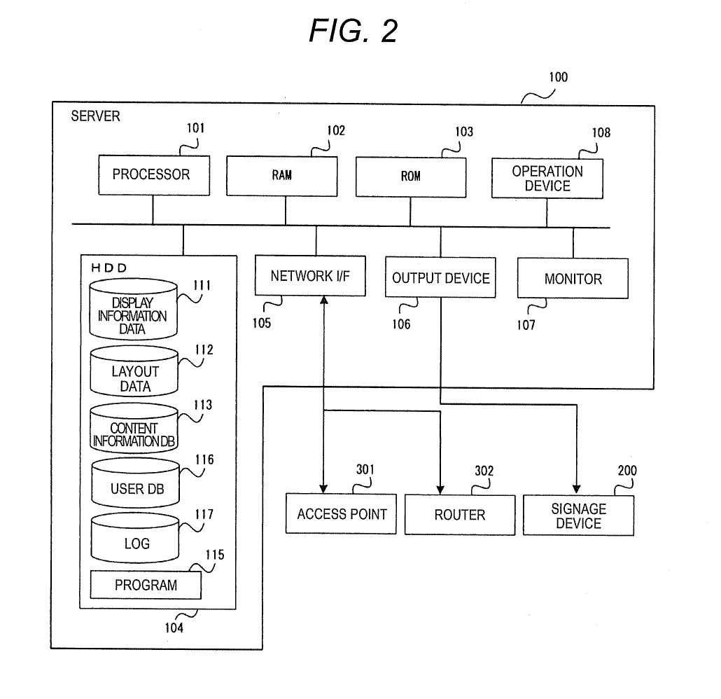

A description will be made regarding the configuration of the server 100, with reference to FIG. 2. The server 100 includes a processor 101, a random access memory (RAM) 102, a read only memory (ROM) 103, a hard disk drive (HDD) 104, a network interface (I/F) 105, an output device 106, a monitor 107, and an operation device 108. The processor 101 is an arithmetic unit such as a central processing unit (CPU). The processor 101 provides various functions in cooperation with respective hardware by developing the program stored in the ROM 103 and the program 115 stored in the HDD 104 in the RAM 102, and calculating and executing the program. The RAM 102 is a main memory, and the ROM 103 is a device that stores a system startup program and the like in a non-volatile manner. The HDD 104 is an auxiliary storage device that stores programs and data in a non-volatile manner.

The network I/F 105 is a LAN board, and performs communication between the access point 301 and the router 302. The network I/F 105 transmits data of the management screen to the portable terminal 401 to 403 and the PCs 501 and 502, through the access point 301 and the router 302. Further, the network I/F 105 receives update data of content that is input by using the management screen and data about an update timing, from the portable terminal 401 to 403, and PCs 501 and 502.

The output device 106 is a device including an HDMI terminal, a DVI terminal, and a controller that controls a video output, and is connected to the signage device 200, through a cable. The monitor 107 and the operation device 108 (for example, a keyboard and a mouse) are operation display units when the administrator of the server 100 performs maintenance.

The HDD 104 stores display information 111, layout data 112, a content information DB 113 (DB: database), a user DB 116, a log 117, and a program 115.

The program 115 has a Web server function, and includes a code group to be executed in response to an instruction received from a client (in this example, portable terminals 401 to 403, and PCs 501 and 502). Further, the program 115 includes a code for controlling the display of the signage device 200, a code for executing an update process, and a code for the report output function.

The display information 111 is a data group obtained by summarizing images and captions of products and held events (a title or a short description of content, a character string describing content in words, and the like) displayed on the signage device 200. The layout data 112 is a data group defining positions when displaying an image and the like on the signage device 200.

The content information DB 113 is a database that stores detailed content data of the content, which is associated with each piece of information of the display information 111. For example, in a case of a store selling clothes, the content information DB 113 stores various types of information such as identification information of content, a file name of an image that the signage device 200 displays, a product name and a price of clothes displayed on the image, the presence or absence of inventory for each color, a coordination example (a combination example of clothes recommended by a store), and a remarks column, as one record. Further, text information such as information of whether the product is to be marked down is stored in the remarks column. The various types of information in these records and the image and caption displayed on the signage device 200 are delivered to the portable terminal of the user.

The user DB 116 stores various types of information such as a user name and a password of an administrator, and the presence or absence of the setting authority of each management item, as one record. The log 117 stores a use history, a delivery history, an update history, and an occurring error of the information providing system 1 as a log.

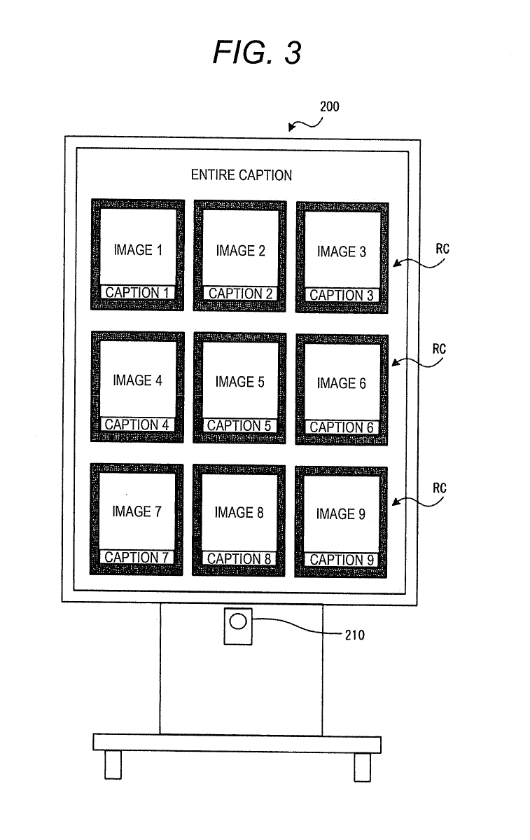

Next, a display example of the signage device 200 is illustrated in FIG. 3. The signage device 200 lists and displays a plurality of pieces of tenant information RC while aligning the information pieces in the vertical and horizontal directions. In the present embodiment, the tenant information is listed and displayed, but the layout is not limited thereto. The tenant information RC is display data constituted by an image, a caption, and a design template (for example, data for overlapping a visual effect on an image) as one set. The display content of one piece of tenant information RC can be switched at predetermined time intervals, based on the control of the server 100. For example, images of clothes, images representing the prices of the clothes, and images of the stores dealing with the clothes can be switched in one piece of tenant information RC, at regular intervals. The signage device 200 can perform display in such a manner that the image of clothes is displayed, for example, for five seconds, thereafter, the price image is displayed for five seconds, and after five seconds pass, the store image is displayed in one piece of tenant information RC, (in this status, if five seconds more pass, the display returns to the original image of clothes).

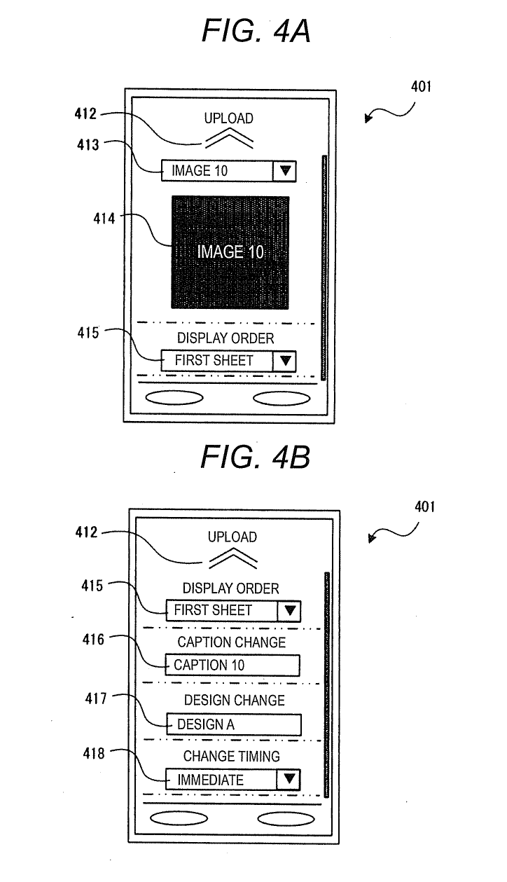

Next, FIGS. 4A and 4B illustrate a display example of the portable terminal 401, in a case of updating using the portable terminal 401. Further, here, the portable terminal 401 is described as an example, but the same is applied to another portable terminal and the PC. The display is performed by the Web browser of the portable terminal 401 accessing a predetermined page of the Web server of the server 100. In other words, a dedicated application may not be introduced to the portable terminal 401.

First, FIG. 4A will be described. The maintenance person selects the contents of which tenant information RC is to be changed by using a tenant selection area 413. Further, if the maintenance person presses an area 414 for a long period of time, the portable terminal 401 displays an image selection screen. The image selected by the screen is displayed in the area 414. An order selection area 415 is a selection area for determining in which order the image is to be displayed.

When the setting item does not fit on a screen, the display screen slides according to the slide operation of the maintenance person, and transitions as illustrated in FIG. 4B.

In continuation, FIG. 4B will be described. A caption, input area 416 is an area for inputting a caption associated with an image. A design selection area 417 is an area for selecting a design template. A change timing selection area 418 is an area for setting an update timing. In the present embodiment, it is possible to select the update timing among
“Immediate”,
“Designated time”,
“Timing when there is no a person in front of the signage”, and
“Timing when a used terminal is not connected to the signage”.

In a state where the display content reaches the end of the selected item (in the present example, a change timing), in other words, in a state where the change timing selection area 418 is displayed at the bottom, if the maintenance person strongly slides a finger upward, the portable terminal 401 transmits these types of input information, and the images to the server 100. Otherwise, the portable terminal 401 transmits the input information and the image by pressing the upload button 412. The PCs 501 and 502 can perform the same setting.

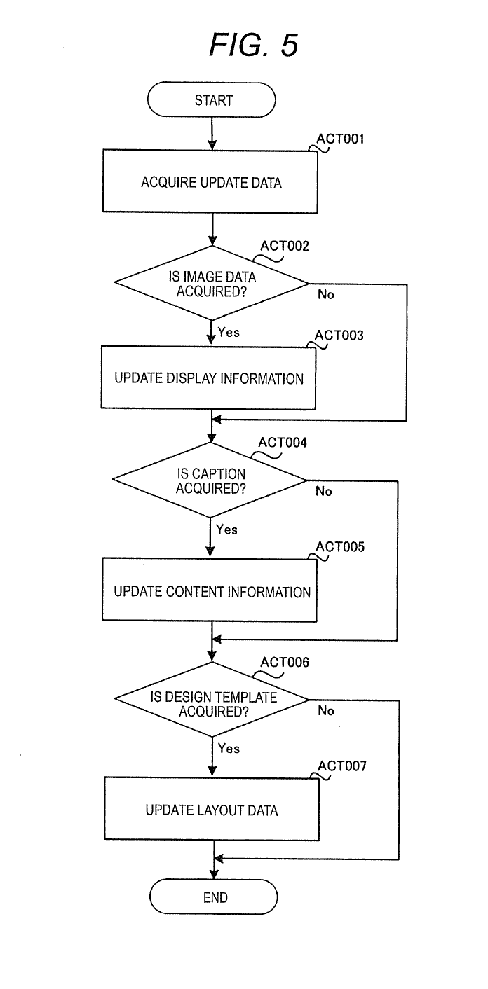

If the server 100 receives the update data, the server 100 checks the update timing, and in the case of “immediate”, the flowchart illustrated in FIG. 5 is executed. The flowcharts illustrated in FIG. 5 and the subsequent drawings are implemented by the processor 101 of the server 100 that calculates and executes the program 115 which is introduced in advance to the HDD 104 and cooperates with the other hardware.

First, the processor 101 acquires update data (information which is selected and input by the maintenance person) transmitted from the portable terminal 401, through the network I/F 105 (ACT 001), and checks the presence or absence of image data (ACT 002). If there is image data (ACT 002-Yes), the processor 101 additionally registers the image in the display information data 111 (ACT 003). If there is not image data (ACT 002, No), ACT 003 is skipped. Then, the processor 101 checks the presence or absence of a caption (ACT 004), and if there is the caption (ACT 004-Yes), the display information data 111 is updated (ACT 005). If there is no caption (ACT 004-No), ACT 005 is skipped. Then, the presence or absence of a design template is checked (ACT 006), and if there is a change (ACT 006-Yes), the processor 101 updates the display information data 111 and the layout data 112 (ACT 007). If there is not a change in the design template (ACT 006, No), ACT 007 is skipped. If the updating of data is detected, the program 115 switches the display content of the tenant information RC corresponding to “immediate” to the update data.

Further, when the update timing is “designated timing”, the update process (operation of FIG. 5) is performed at the designated timing. In this case, the update data transmitted from the portable terminal 401 is temporarily stored in a separate area until the designated timing. If it becomes the designated timing, the processor 101 performs the update of data by executing the operation of FIG. 5.

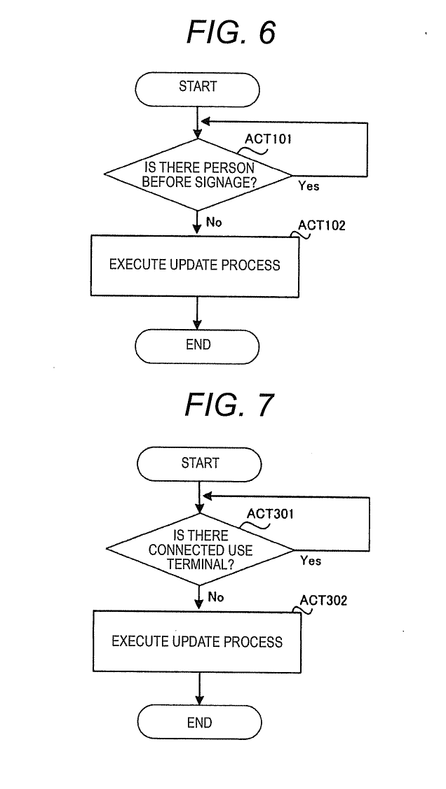

When the update timing is “timing when there is not a person in front of the signage”, the processor 101 executes the operation illustrated in FIG. 6. The processor 101 determines whether or not there is a person in front of the signage, based on the signal from the human sensor 210 provided in the signage device 200 (ACT 101). When there is not a person (ACT 101-No), the processor 101 executes the update process illustrated in FIG. 5 (ACT 102). Even in this case, data transmitted from the portable terminal 401 is temporarily stored in a separate area, and is updated at a timing when there is not a person.

Then, when the update timing is “timing when a used terminal is not connected to the signage”, the processor 101 executes the operation illustrated in FIG. 7. The processor 101 determines whether or not the portable terminal of the user is connected to the server 100 (ACT 301). When there is no connected portable terminal of the user (ACT 301-No), the processor 101 executes the update process illustrated in FIG. 5 (ACT 302). Even in this case, update data transmitted from the portable terminal 401 is temporarily stored in a separate area, and is updated at a timing when there is no data connection.

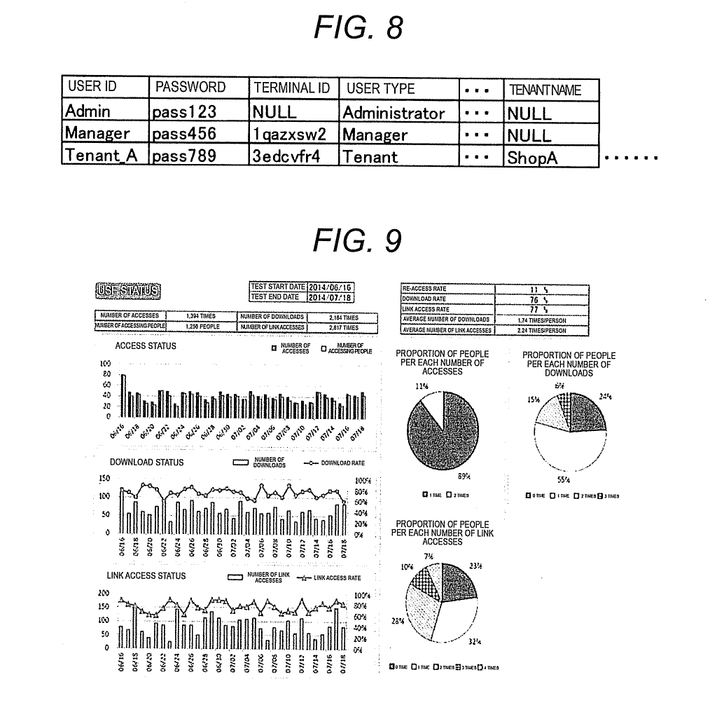

The update process illustrated in FIG. 5 shows a case of updating the display of a portion of the signage device 200, but the update range is set for each user. FIG. 8 illustrates a data configuration example of the user information. The user information is stored in the user DB 116 of the HDD 104. As illustrated in FIG. 8, for example, the Admin who is the provider of the information providing system 1 is an account having all operation authorities (Administrator authority), and can update and view all pieces of information. Further, Manager (user type is “Manager”) who is an administrator of the signage device 200 can update all pieces of display information, the content information, and the design of the signage device 200. In the case of the display example illustrated in FIG. 3, the Admin and the Manager can update character strings present at the position of “whole caption” and overall background design.

Then, Tenant_A which is an administrator of a Tenant, of which the user type is Tenant, and can update part of the display information and part of the content information of the signage device 200 and the Tenant_A's own user information. When the user type is Tenant, the Tenant_A can update only the assigned tenant information RC, and cannot update the tenant information RC of other people.

The user whose user type is “Administrator” or “Manager” can select all pieces of the tenant information RC from the tenant selection area 413 (see FIG. 4A). Meanwhile, the user whose user type is “Tenant” can select only the assigned tenant information RC, and the display is controlled so that other types of tenant information RC are not to be selected.

Further, each user is stored in association with a terminal ID in the user DB 116, and thus when fixed portable terminals 401 to 403 or PCs 501 and 502 access the server 100, it is possible to output a suitable update setting screen. In this case, screen control for permission or prohibition of the tenant selection described above is controlled for each device.

Meanwhile, the display screen may be switched when the portable terminals 401 to 403 are connected to the server 100, or when the PCs 501 and 502 are connected to the server 100.

Next, the report output function will be described. The maintenance person can check the report illustrated in FIG. 9 by performing a predetermined operation in the portable terminals 401 to 403 and PCs 501 and 502. If the server 100 receives a report request message from the PCs 501 and 502, and the portable terminals 401 to 403, the server 100 forms a use log, an update log, and an error log which are stored in the log 117 at any time into a report format, and transmits the logs to a requesting device. The use log is output when the user downloads detailed information. Further, the use log is also output when a human detection signal is received by the human sensor 210. The processor 101 generates a separate report corresponding to the authority, based on the user information illustrated in FIG. 8, and controls the viewing of the log. For example, the user whose user type is “Administrator” and the device corresponding thereto can view a management log, an error log, and an access log (use log) for all pieces of the tenant information, and display a report. The user whose user type is “Manager” and the device corresponding thereto can select an access log for all pieces of the tenant information and display a report, but cannot access the management log and the error log. Further, the user whose user type is “Tenant” can only select an access log for the assigned tenant information, and display a report.

The report example illustrated in FIG. 9 represents a use record, but an update report may be output to the Manager, or an error report may be output to the Admin. Further, a report regarding the ranking of content information displayed for each Tenant and the like may be displayed.

By adopting such a configuration, it is possible to properly manage and update the information providing system.

### Other Embodiments

A description will be made regarding an embodiment in which the server 100 receives update content through an e-mail, and updates the display information and the content information of the signage device 200.

The maintenance person performs the setting described with reference to FIGS. 4A and 4B by using the Web browser of the portable terminals 401 to 403, and the PCs 501 and 502, and performs an upload operation. By the operation, various types of setting data are converted into a prescribed format. The portable terminals 401 to 403, and the PCs 501 and 502 transmit data to the e-mail address which is assigned in advance as the dedicated address of the server 100.

If the server 100 receives an e-mail, the processor 101 analyzes the description contents of the mail text, according to the prescribed format, and extracts each setting item. The processor 101 acquires the update timing from the setting items. When the update timing is “immediate”, the processor 101 executes the update process illustrated in FIG. 5. When the update timing is “designated time”, the processor 101 executes the update process illustrated in FIG. 5 at a designated timing; and when the update timing is “timing when there is not a person in front of the signage”, or “timing when a used terminal is not connected to the signage”, the update is performed as described above (see FIG. 6 and FIG. 7). Image data is attached to the e-mail, and the caption and the design template are described in the mail text or are included in the attached data. The processor 101 extracts these types of data and executes the update process.

In the present embodiment, a description is made regarding a case where the function of performing the exemplary embodiment is recorded in the apparatus in advance, but without being limited thereto, the same function may be downloaded to the apparatus from the network, or the same function stored in a recording medium may be installed in the apparatus. As long as a recording medium such as a CD-ROM can store a program and can be read by the apparatus, any form of recording medium may be used. Further, the function obtained by being installed or downloaded in advance in such a manner may be one that realizes the function in cooperation with an operating system (OS) inside the apparatus.

Further, a first terminal device corresponds to the portable terminals 401 to 403, and the PCs 501 and 502 in the above embodiment. A second terminal device corresponds to the portable terminal that the user owns in the above embodiment.

The content is data displayed on the signage device, and is described as the image data, the caption, and the design template as an example in the present embodiment. Further, the detailed information for delivery defined in the content information DB 113 may be included in the content.

As described in detail above, since the Web based data update screen is provided in the embodiment, it is not necessary to introduce an application and the like to the terminal. Further, since it is possible to set a timing of when to perform updating, it is possible to update the display content of the signage device at a timing other than when the visitor performs access.

It is possible to perform the present exemplary embodiment in various ways, without departing from the spirit or essential characteristics. Therefore, the embodiments described above are merely exemplary in all respects, and are not limitedly interpreted. The scope of the present exemplary embodiment is represented by the claims, and is not limited by the specification text. All of modifications, various improvements, alternatives and reforms belonging to the equivalent scope of the claims are within the scope of the exemplary embodiment.

What is claimed is:

1. An information providing apparatus which displays information on a signage device and controls the signage device, comprising:
an interface that transmits data of a management screen for updating one or a plurality of contents displayed on the signage device, to a first terminal device, and receives update data of the content which is input by using the management screen and data about an update timing, from the first terminal device; and
a control unit that updates existing data displayed on the signage device to the update data, according to the data about the update timing.

2. The apparatus according to claim 1,
wherein the update timing includes a timing when a second terminal device which is a terminal device of a user who views the signage device and the information providing apparatus are not data-connected, and
wherein the control unit updates existing data to the update data when the information providing apparatus does not perform data connection with the second terminal device.

3. The apparatus according to claim 1,
wherein the update timing includes a timing when there is not a person in front of the signage device, and
wherein the control unit acquires detection information of whether or not there is a person in the vicinity of the signage device, and updates the existing data to the update data when there is not a person.

4. The apparatus according to claim 2,
wherein the control unit further generates a report regarding a use status of the signage device, and
wherein the interface transmits the report to the first terminal device.

5. The apparatus according to claim 1,
wherein the control unit performs control so as to permit a first user to update only content displayed on the signage device and assigned in advance, and permit a second user to update all of the content.
